(19) United States
(12) Patent Application Publication
(10) Pub. No.: US 2014/0317105 A1
(43) Pub. Date: Oct. 23, 2014

(54) LIVE RECOMMENDATION GENERATION

(71) Applicant: Google Inc., (US)

(72) Inventors: Ankit Jain, Milpitas, CA (US); Abhinav Khandelwal, Mumbai Maharashtra (IN)

(73) Assignee: Google Inc., Mountain View, CA (US)

(21) Appl. No.: 13/868,341

(22) Filed: Apr. 23, 2013

(51) Int. Cl. G06F 17/30

(52) U.S. Cl. CPC G06F 17/30011
USPC 707/731

(57) ABSTRACT

A system and/or method is provided for using a scatter gather information retrieval system for live recommendation generation. The method may include retrieving user information classified in a plurality of categories. For at least one of the plurality of categories, a document recommendation query may be generated based on the user information classified in a corresponding one of the plurality of categories. For each generated recommendation query, a plurality of documents satisfying the recommendation query may be retrieved from a corpus of documents. The corpus may classify a plurality of documents of a determined type available for consumption by the user. Each retrieved plurality of documents may be ranked to generate a final list of recommendations for the user. Each of the plurality of documents may include identifying information for a book, a song, a video, a movie, a music album, an application, and/or a TV show.

### BACKGROUND

Conventional recommendation engines are mainly based on a combination of offline processes, with sporadic lookups at query time. However, there are several drawbacks of such recommendation engines. For example, recommendations for all users have to be generated constantly, at regular time intervals, regardless of whether or not a user has returned to the recommendations destination. Additionally, since the recommendations are based on offline processes, the conventional recommendation engine does not take into account real-time feedback based on actions by the user.

Further limitations and disadvantages of conventional and traditional approaches will become apparent to one of skill in the art, through comparison of such approaches with some aspects of the present method and apparatus set forth in the remainder of this disclosure with reference to the drawings.

### SUMMARY

A system and/or method is provided for using a scatter gather information retrieval system for live recommendation generation, substantially as shown in and/or described in connection with at least one of the figures, as set forth more completely in the claims.

These and other advantages, aspects and features of the present disclosure, as well as details of illustrated implementation(s) thereof, will be more fully understood from the following description and drawings.

In accordance with an example embodiment of the disclosure, a method is provided for using a scatter gather information retrieval system for live recommendation generation. The method may include retrieving user information classified in a plurality of categories. For at least one of the plurality of categories, a document recommendation query may be generated based on the user information classified in a corresponding one of the plurality of categories. For each generated recommendation query, a plurality of documents satisfying the recommendation query may be retrieved from a corpus (or corpora) of documents. The corpus may classify a plurality of documents of a determined type available for consumption by the user. The retrieved plurality of documents may be ranked to generate a final list of recommendations for the user.

In accordance with another example embodiment of the disclosure, a system for providing recommendations to a user may include a network device with at least one processor coupled to a memory. The at least one processor may be operable to retrieve user information classified in a plurality of categories. For at least one of the plurality of categories, a document recommendation query may be generated based on the user information classified in a corresponding one of the plurality of categories. For each generated recommendation query, a plurality of documents satisfying the recommendation query may be retrieved from a corpus (or corpora) of documents. The corpus may classify a plurality of documents of a determined type available for consumption by the user. The retrieved plurality of documents may be ranked to generate a final list of recommendations for the user.

In accordance with yet another example embodiment of the disclosure, a method for providing recommendations to a user may include retrieving user information classified in a plurality of categories, and information related to recent content consumed by the user. At least one document recommendation query may be generated based on the retrieved user information. For each of the at least one document recommendation query, a plurality of documents satisfying the recommendation query may be retrieved from a corpus (or corpora) of documents. The corpus may classify a plurality of documents of a determined type available for consumption by the user. Each retrieved plurality of documents may be ranked based on the recent content consumed by the user, to generate a final list of recommendations for the user.

### BRIEF DESCRIPTION OF THE DRAWINGS

FIG. 1 is a block diagram illustrating an example architecture for generating live recommendations using a “scatter gather” information retrieval system, in accordance with an example embodiment of the disclosure.

FIG. 2 is a block diagram illustrating an example database with user-related information, which may be used during the live recommendation generation illustrated in FIG. 1, in accordance with an example embodiment of the disclosure.

FIG. 3 is a block diagram illustrating a backend server architecture, which may be used during the live recommendation generation illustrated in FIG. 1, in accordance with an example embodiment of the disclosure.

FIG. 4 is a flow chart illustrating example steps of a method for providing recommendations to a user, in accordance with an example embodiment of the disclosure.

FIG. 5 is a flow chart illustrating example steps of another method for providing recommendations to a user, in accordance with an example embodiment of the disclosure.

FIG. 6 is a flow chart illustrating example steps of a method for providing recommendations to a user based on recent user behavior, in accordance with an example embodiment of the disclosure.

### DETAILED DESCRIPTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the term “e.g.,” introduces a list of one or more non-limiting examples, instances, or illustrations. As utilized herein, the term “processor” may be used to refer to one or more of a central processing unit, a processor of a symmetric or asymmetric multiprocessor system, a digital signal processor, a micro-controller, a graphics/video processor, or another type of processor.

The present disclosure relates to a method and system for using a “scatter gather” information retrieval system for live recommendation generation. Conventional recommendation engines categorize the users into different categories and then suggest recommendations based on these categories. Additionally, conventional recommendation systems store the generated (or “processed”) user recommendations periodically for subsequent use.

In accordance with an example embodiment of the disclosure, a search engine architecture may be used to provide real time recommendations across different content verticals with low latencies. The real time recommendations may be provided by storing multiple kinds of documents in the index and serving corpus of the search engine (e.g., documents that are about users as well as documents that are about items and their relations to different properties, such as which other items they are popular with, related to, as well as which regions or age groups they are popular in). The retrieval and ranking of the recommendations may then be separated into two phases, and only searching portions of the corpus (e.g., the various corpora or content verticals) that need to be searched.

More specifically, during a first phase, information about the user may be gathered. During a second phase, a “scatter gather” system may be used to retrieve a plurality of documents (e.g., apps, books, songs, movies, etc.) that the user can potentially be interested in, and then rank these retrieved items to generate recommendations for presenting to the user. A “scatter gather” system may include a single server (or a “root”), which may be operable to generate and communicate at least one document recommendation request or query to a plurality of other backend servers (or “leaves”) associated with a corpora (e.g., corpus 1, . . . , corpus N) of documents. For example, each corpus (1, . . . , N) may be associated with one or more of the “leaves”. Additionally, each of the “leaves” may be operable to retrieve and score/rank documents in response to the request or query received from the “root”. After the scoring/ranking of retrieved documents, the top documents from each “leave” may be returned to the “root”. The “root” may then gather, merge, and sort the documents from all of the “leaves” and return a final list of top results to the user. In this way, by using a “scatter gather” system, storing of “processed” user recommendations, which is typical of the conventional recommendation engines, may be avoided and all recommendation processing and presentation to the user may be achieved in real time.

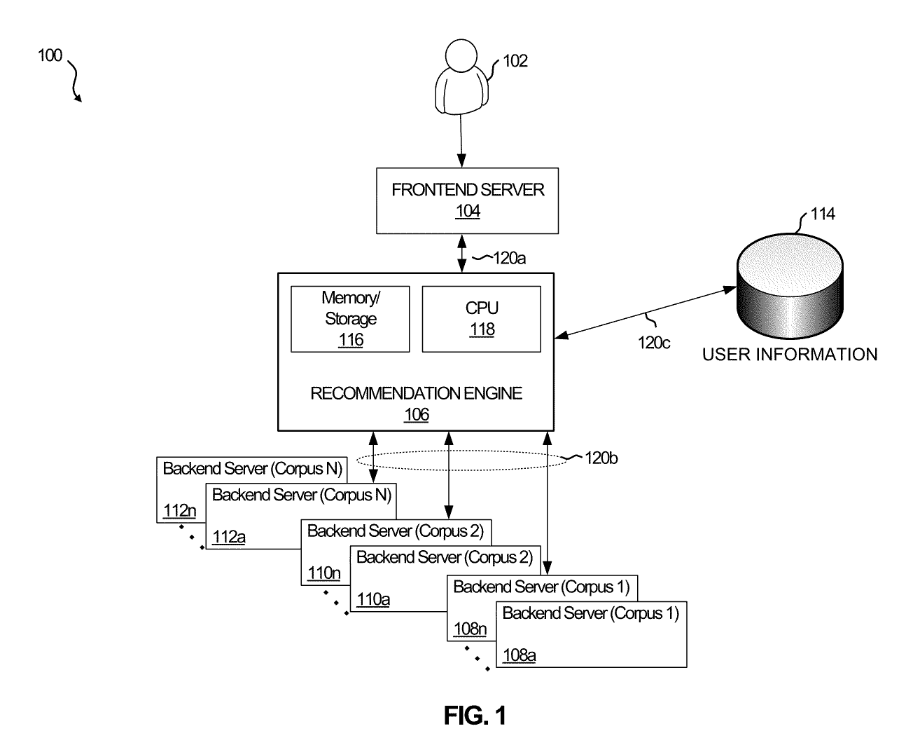

FIG. 1 is a block diagram illustrating an example architecture for generating live recommendations using a “scatter gather” information retrieval system, in accordance with an example embodiment of the disclosure. Referring to FIG. 1, the architecture 100 may comprise a frontend server 104, a recommendation engine 106, a user information database 114, and a plurality of backend servers 108a, . . . , 112a.

The frontend server 104 may comprise suitable circuitry, logic and/or code and may be operable to provide a media consumption environment to the user 102. For example, the frontend server 104 may provide online media store functionalities (e.g., sale of songs, apps, books, movies, etc.), personal media locker services (cloud-based media storage) and other media-related functions.

The recommendation engine 106 may comprise memory/storage 116, CPU 118, as well as other suitable circuitry, logic and/or code, and may be operable to provide one or more recommendations to the frontend server 104 for presentation to the user 102. For example, the recommendation engine 106 may receive (e.g., via wired and/or wireless connection 120a) user credentials (for user 102) from the frontend server 104 (e.g., after the user 102 logs in to a media web store or a media search engine maintained by the frontend server 104). The recommendation engine 106 may then receive user-related information (for user 102) from the user information database 114 via the wired and/or wireless connection 120c. The recommendation engine 106 may then generate one or more document recommendation requests or queries based on the received user-related information.

The generated document recommendation queries may be communicated to the backend servers 108a, . . . , 112n (e.g., via wired and/or wireless connections 120b), which may search one or more search corpus (e.g., corpus 1, . . . , N) and return a plurality of documents matching the document recommendation queries. Each backend server (“leaf”) does a local scoring/ranking of retrieved documents and returns the top results to the recommendation engine (“root”) 106. In some instances, each of the root servers within the recommendation engine 106 may retrieve and score/rank documents in response to the document recommendation queries received from the backend servers 108a . . . 112n. The recommendation engine may generate a final list of recommendations to be returned to the frontend server 104 for presentation to the user 102.

The backend servers 108a, . . . , 112n may comprise suitable circuitry, logic and/or code and may be operable to provide, for example, searching and document retrieval functionalities. In this regard, one or more of the backend servers 108a, . . . , 112n may be associated with a respective corpus (e.g., corpus 1, . . . , N) comprising documents of certain type. For example, corpus 1 may be associated with backend servers 108a, . . . , 108n, and may comprise music-related items (e.g., music tracks, albums, etc.). Corpus 2 may be associated with backend servers 110a, . . . , 110n and may comprise applications (or apps) related documents. Corpus N may be associated with backend servers 112a, . . . , 112n and may comprise books related documents.

Even though the recommendation engine 106 is illustrated separate from the frontend server 104 and the backend servers 108a, . . . 112n, the present disclosure may not be limited in this regard. More specifically, the recommendation engine 106 may be implemented as part of the frontend server 104 or one of the backend servers 108, . . . , 112.

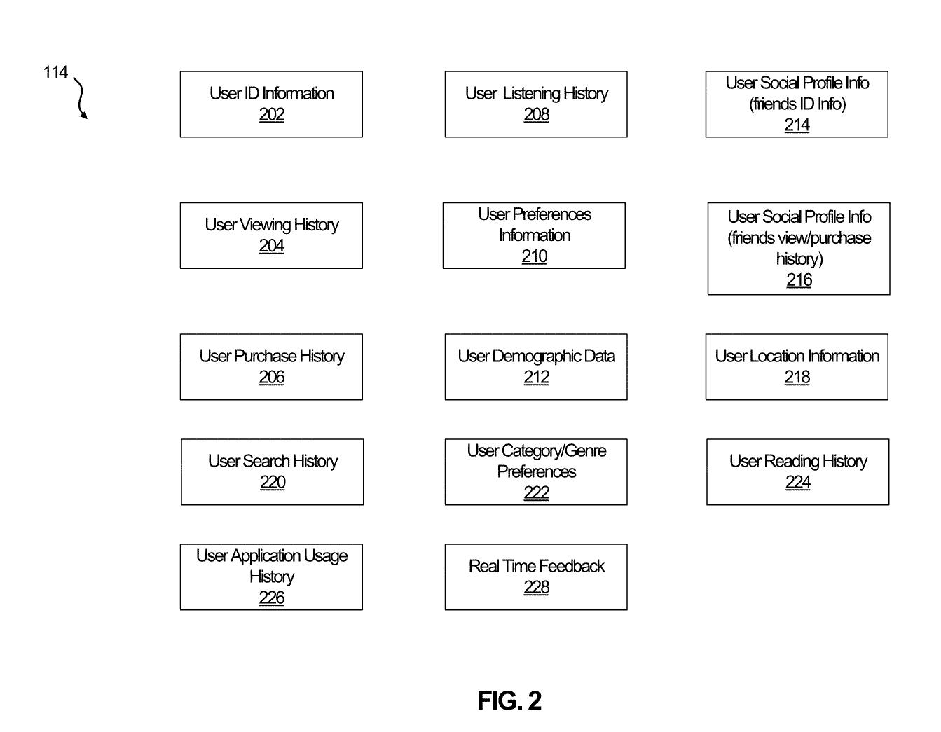

In operation, the user 102 may provide user credentials (e.g., login information, password, etc.) to the frontend server 104 for logging in to a media-related service provided by the frontend server 104. The frontend server 104 may communicate the user 102 credentials to the recommendation engine 106 via communication path 120a. The recommendation engine 106 may then use the received user credentials (i.e., user identity information) as a first pass query to the user information database 114 (via the communication path 120c). In response to the query, the database 114 may return user-related information back to the recommendation engine 106 (e.g., information about user's friends, user's content consumptions, any information about the user that user 102 has previously provided to the frontend server 104, or information that may be inferred from the available user data, user location, etc.). More specific examples of user-related information are provided herein below in reference to FIG. 2.

In this regard, a “scatter gather” system may be implemented by using the recommendation engine 106 as the initiating single server (or a “root”), which may be operable to generate and communicate at least one document recommendation request or query to the plurality of backend servers (or “leaves”) 108a, . . . , 112n associated with a corpora (e.g., corpus 1, . . . , corpus N) of documents. The recommendation engine 106 may then generate one or more document recommendation queries based on the received user-related information, and may send the document recommendation queries to the backend servers 108a, . . . , 112n (i.e., a “scatter” step). The backend servers 108a, . . . , 112n may each perform a search and retrieve candidate content for user recommendations. The retrieved documents may be scored/ranked and a top list of documents may be returned back to the recommendation engine 106, which may use the user-related data to further score and rank the received documents in order to generate a final list of recommendations for the user (i.e., the “gather” step). The final list may be further mixed so that recommendations from multiple document types (e.g., apps, music, videos, books, etc.) are present in the final list of recommendations. The recommendation engine 106 may then communicate the final list of recommendations to the frontend server 104 for presentation to the user 102. The recommendation list generation functionalities described herein may be performed in real time (e.g., upon logging in of the user 102 into the media-related services provided by the frontend server 104) and may be updated periodically.

FIG. 2 is a block diagram illustrating an example database with user-related information, which may be used during the live recommendation generation illustrated in FIG. 1, in accordance with an example embodiment of the disclosure. Referring to FIG. 2, there is illustrated a more detailed diagram of the user information database 114. More specifically, the user information database may comprise user identification information 202, information on user's viewing history 204, information on user's purchase history 206 (e.g., purchase of apps, music, videos, movies, books, etc.), and information on user's listening history 208 (e.g., listening history of music stored in user's cloud-based media locker).

The user information database 114 may also comprise user preferences information 210 (e.g., information provided by the user regarding preferred media genre, preferred media type, preferred artists/authors, etc.), user demographic data 212, and user location information 218. The user information database 114 may also comprise user social profile information 214 (e.g., information on user's friends in a social network) and 216 (e.g., information on the user's friends' viewing/purchase history).

The user information database 114 may further include user search history 220, user category/genre preferences 222, user reading history 224, user application usage history 226, and real time feedback information 228. The real time feedback information 228 may comprise recommendation dismissals, recommendation conversions (clicking on a recommendation or buying/installing the recommendation), recommendation approval information (+1, Like, etc.), and recommendation saving (e.g., via a wishlist feature).

Even though only fourteen types of information are illustrated in FIG. 2, the present disclosure may not be limited in this regard and other types of user-related information may also be provided by the database 114.

Referring to FIGS. 1-2, after the recommendation engine 106 receives user-related information from the database 114, it may then generate one or more document recommendation queries based on the received user-related information, and may send the document recommendation queries to the backend servers 108a, . . . , 112n. For example, if the user-related information comprises user viewing history 204 and/or purchase history 206 and/or listening history 208, the document recommendation queries may comprise document similar to what was viewed and/or purchased and/or listened to by the user. If the user-related information comprises user demographic data 212 and/or user location data 218, the document recommendation queries may comprise document popular to the user demographic (e.g., documents popular by other users that are same age as the user 102) and/or documents popular in the specific geographic location of the user.

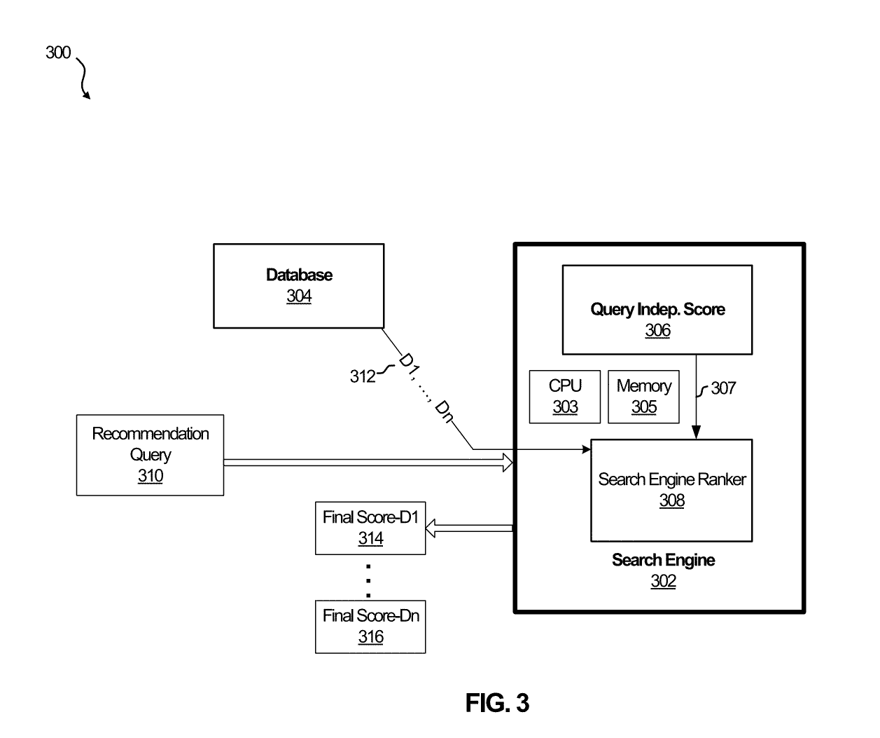

FIG. 3 is a block diagram illustrating a backend server architecture, which may be used during the live recommendation generation illustrated in FIG. 1, in accordance with an example embodiment of the disclosure. Referring to FIG. 3, the example backend server architecture 300 may comprise a search engine 302 and a document database (or corpus) 304.

The document database 304 may comprise suitable circuitry, logic and/or code and may be operable to provide documents of a specific type (e.g., song tracks, videos, books, movies, apps, etc.).

The search engine 302 may comprise suitable circuitry, logic and/or code and may be operable to receive database documents (e.g., documents 312, D1, . . . , Dn) in response to recommendation query 310 from the recommendation engine 106, and rank the received documents 312 based on the document final scores 314, . . . , 316. The search engine 302 may comprise a CPU 303, a memory 305, a query independent score module 306, and a search engine ranker 308.

The query independent score module 306 may comprise suitable circuitry, logic and/or code and may be operable to calculate a query-independent score (e.g., a popularity score) 307 for one or more documents received from the database 304. For example, the query-independent score may comprise a popularity score based on the number of search queries previously received within the backend server architecture 300 about a specific document from the database 304, as well as at least one of query-to-click ratio information and clickthrough ratio (CTR) information for at least one web page search result for the specific document.

The search engine ranker 308 may comprise suitable circuitry, logic and/or code and may be operable to receive one or more documents 312 (e.g., documents D1, . . . , Dn) in response to a document recommendation query 310. The search engine ranker 308 may then rank the received documents 312 based on a final ranking score 314, . . . , 316 calculated for each document using one or more query independent scores 307 (received from the query independent score module 306) and/or one or more query dependent scores. The search engine ranker may generate the final ranking score 314, . . . , 316 for each document based on the query-dependent and/or query-independent scores.

In operation, the recommendation engine 106 may communicate a document recommendation query 310 to the search engine 302. The document recommendation query 310 may be based on the user-related information received by the recommendation engine 106 from the database 114. After the search engine 302 receives the recommendation query 310, the search engine 302 may obtain one or more documents 312 (D1, . . . , Dn) that satisfy the recommendation query 310.

After the search engine 302 receives the documents 312, a query-independent score 307 may be calculated for each of the documents, and the score may be used by the ranker 308 to calculate the final ranking scores 314, . . . , 316 for the documents and output a ranked document search results list back to the recommendation engine 106.

Even though the search engine 302 and the database 304 are all illustrated as separate blocks, the present disclosure may not be limited in this regard. More specifically, the database 304 may be part of, and implemented within, the search engine 302 with all processing functionalities being controlled by the CPU 303. The CPU 303 may be operable to perform one or more of the processing functionalities associated with retrieving and/or ranking of documents, as disclosed herein.

In accordance with an example embodiment of the disclosure, all ranking/scoring functionalities for documents retrieved in response to the document recommendation query 310 may be performed by the recommendation engine 106. In this regard, the backend server architecture 300 (which is representative of one or more of the backend servers 108a, . . . , 112n) may perform the document retrieval functionalities, and ranking/scoring functionalities may be performed after the retrieved documents are communicated back to the recommendation engine 106.

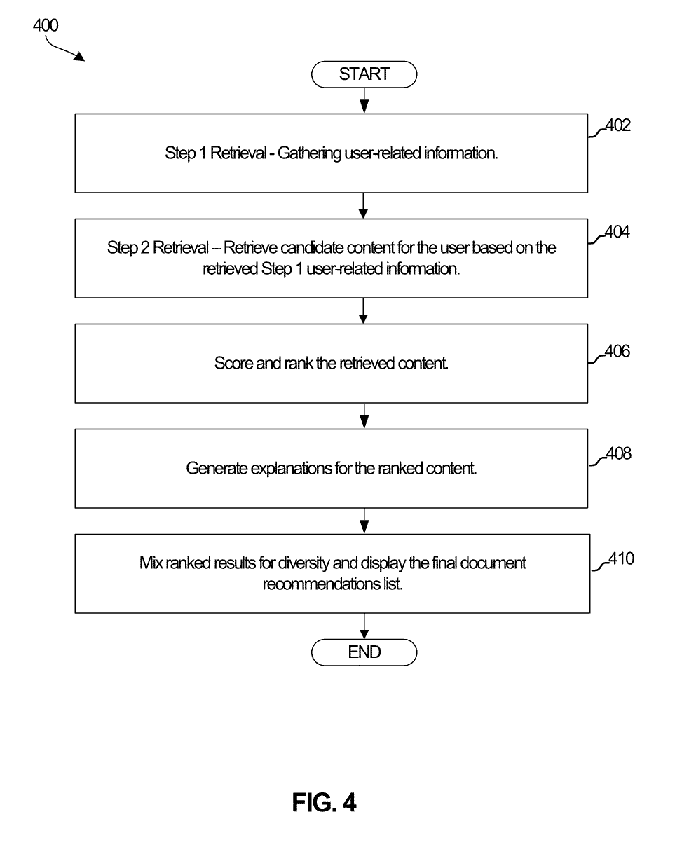

FIG. 4 is a flow chart illustrating example steps of a method for providing recommendations to a user, in accordance with an example embodiment of the disclosure. Referring to FIGS. 1-4, the example method 400 may start at 402, when a Step 1 Retrieval may be performed (e.g., by the recommendation engine 106) by gathering user-related information (e.g., from the database 114). At 404, Step 2 Retrieval may be performed by retrieving candidate content for the user based on the retrieved Step 1 user-related information (e.g., content retrieved by the backend servers 108a, . . . , 112n). At 406, after the retrieved content is communicated back to the recommendation engine 106, the retrieved content may be scored and ranked. At 408, the recommendation engine may generate explanations for the ranked content (e.g., what user information was used to generate the query, which document query was used, etc.). At 410, the recommendation engine 106 may mix the ranked results for diversity and may communicate the final document recommendations list to the frontend server 104 for display.

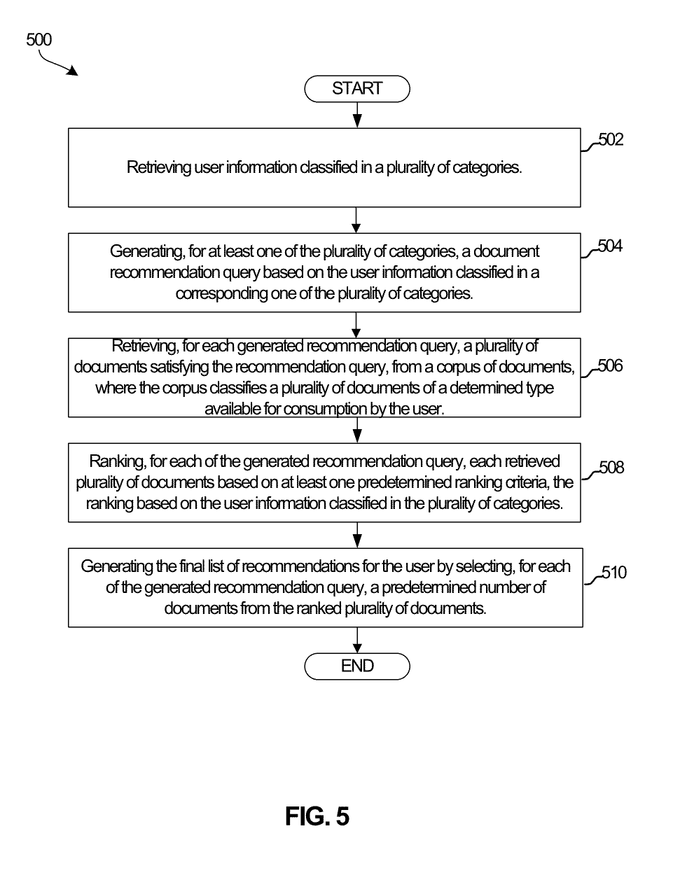

FIG. 5 is a flow chart illustrating example steps of another method for providing recommendations to a user, in accordance with an example embodiment of the disclosure. Referring to FIGS. 1-3 and 5, the example method 500 may start at 502, when user information classified in a plurality of categories (e.g., 202, . . . , 218) may be retrieved from the database 114 (e.g., by the recommendation engine 106). At 504, the recommendation engine 106 may generate, for at least one of the plurality of categories, a document recommendation query based on the user information classified in a corresponding one of the plurality of categories.

At 506, the backend servers 108a, . . . , 112n may retrieve, for each generated recommendation query, a plurality of documents satisfying the recommendation query, from a corpus of documents (e.g., one or more of corpus 1, . . . , N). The corpus (e.g., one or more of corpus 1, . . . , N) may classify a plurality of documents of a determined type available for consumption by the user (e.g., each corpus 1, . . . , N may be associated with a given type of documents, such as music, apps, books, videos, movies, etc.). At 508, the recommendation engine 106 may rank, for each of the generated recommendation query, the retrieved plurality of documents based on at least one predetermined ranking criteria. The ranking may be based on the user information classified in the plurality of categories. At 510, the recommendation engine may generate the final list of recommendations for the user by selecting, for each of the generated recommendation query, a predetermined number of documents from the ranked plurality of documents. The final list of recommendations may then be communicated to the frontend server 102 for presentation to the user 102.

In accordance with an example embodiment of the disclosure and in reference to the architecture 100 in FIG. 1, the recommendation engine 106 may user hyper-recent user behavior (i.e., content consumed in the recent past) to give higher weight to the content (e.g., documents retrieved by the backend servers 108a, . . . , 112n) similar to the recent content that was consumed by the user. In this regard, the personalization of the final recommendation list provided to the user 102 may be further improved by selecting a higher weight to retrieved content that is similar to recently consumed content.

In some instances, in addition to (or in lieu of) information on recent user consumption history, the recommendation engine 106 may also use information on how the user reached the current content to provide the recommendations. For example, relevant information may include what did the user watch/listen before the recent content, or what queries did the user use to reach the recent content. This information may be used to determine the current user intent and to rank the content received from the backend servers 108a, . . . , 112n.

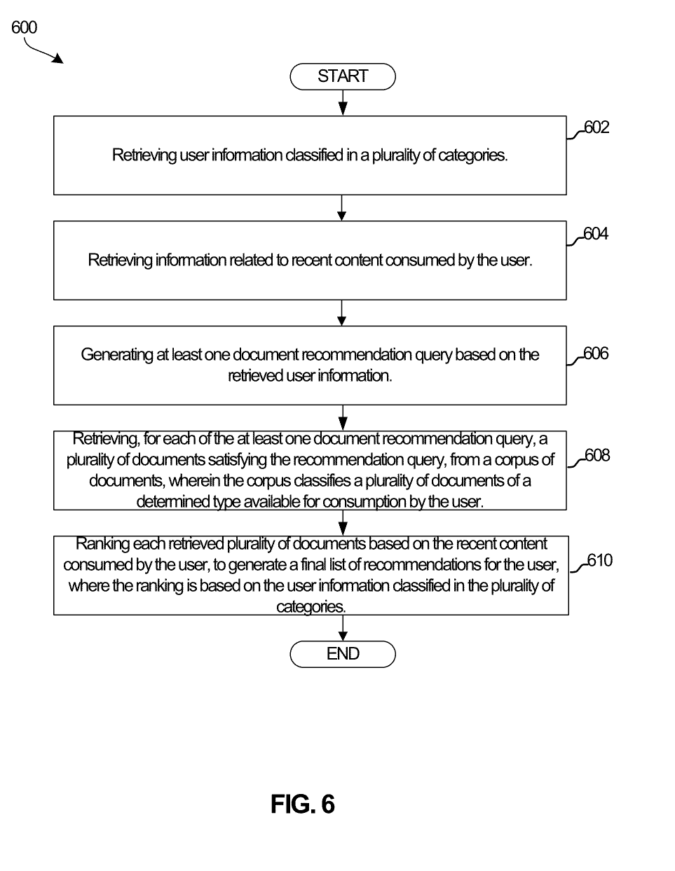

FIG. 6 is a flow chart illustrating example steps of a method for providing recommendations to a user based on recent user behavior, in accordance with an example embodiment of the disclosure. Referring to FIGS. 1-3 and 6, the example method 600 may start at 602, when user information classified in a plurality of categories (e.g., 202, . . . , 218) may be retrieved from the database 114. At 604, information related to recent content consumed by the user 102 may be retrieved from the database 114.

At 606, at least one document recommendation query may be generated by the recommendation engine 106 based on the retrieved user information. At 608, the backend servers 108a, . . . , 112n may retrieve, for each of the at least one document recommendation query, a plurality of documents satisfying the recommendation query, from a corpus of documents (e.g., one or more of corpus 1, . . . , N). The corpus (e.g., one or more of corpus 1, . . . , N) may classify a plurality of documents of a determined type available for consumption by the user (e.g., each corpus 1, . . . , N may be associated with a given type of documents, such as music, apps, books, videos, movies, etc.). At 610, each retrieved plurality of documents may be ranked (e.g., by the recommendation engine 106) based on the recent content consumed by the user, to generate a final list of recommendations for the user 102.

Other implementations may provide a machine-readable storage device, having stored thereon, a machine code and/or a computer program having at least one code section executable by a machine and/or a computer, thereby causing the machine and/or computer to perform the steps as described herein for providing recommendations to a user.

Accordingly, the present method and/or system may be realized in hardware, software, or a combination of hardware and software. The present method and/or system may be realized in a centralized fashion in at least one computer system, or in a distributed fashion where different elements are spread across several interconnected computer systems. Any kind of computer system or other system adapted for carrying out the methods described herein is suited. A typical combination of hardware and software may be a general-purpose computer system with a computer program that, when being loaded and executed, controls the computer system such that it carries out the methods described herein.

The present method and/or system may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present method and/or apparatus has been described with reference to certain implementations, it will be understood by those skilled in the art that various changes may be made and equivalents may be substituted without departing from the scope of the present method and/or apparatus. In addition, many modifications may be made to adapt a particular situation or material to the teachings of the present disclosure without departing from its scope. Therefore, it is intended that the present method and/or apparatus not be limited to the particular implementations disclosed, but that the present method and/or apparatus will include all implementations falling within the scope of the appended claims.

What is claimed is:

1. A method for providing recommendations to a user, comprising:
retrieving user information classified in a plurality of categories;
generating, for at least one the plurality of categories, a document recommendation query based on the user information classified in a corresponding one of the plurality of categories;
retrieving, for each generated recommendation query, a plurality of documents satisfying the recommendation query, from a corpus of documents, wherein the corpus classifies a plurality of documents of a determined type available for consumption by the user; and
ranking each retrieved plurality of documents to generate a final list of recommendations for the user, wherein the ranking is based on the user information classified in the plurality of categories.

2. The method according to claim 1, wherein the plurality of categories comprise two or more of:
user identification information comprising user name and age;
user location and demographic;
previous user purchases of documents available for user consumption;
user viewing history;
user media consumption history;
user interests; and
user's friends.

3. The method according to claim 1, wherein each of the plurality of documents comprises identifying information for at least one of a book, a song, a video, a movie, a music album, an application (app), and a TV show.

4. The method according to claim 1, comprising:
ranking, for each of the generated recommendation query, the retrieved plurality of documents based on at least one predetermined ranking criteria.

5. The method according to claim 4, comprising:
generating the final list of recommendations for the user by selecting, for each of the generated recommendation query, a predetermined number of documents from the ranked plurality of documents.

6. The method according to claim 1, wherein, if the user information comprises the user's current location, then the document recommendation query comprises a query for at least one document popular at the user's current location.

7. The method according to claim 1, wherein, if the user information comprises identifying information about the user's friends, then the document recommendation query comprises a query for at least one document similar to:
a document recently purchased by at least one of the user's friends;
a document recommended by at least one of the user's friends; or
a document viewed by at least one of the user's friends.

8. The method according to claim 1, comprising:
for each recommendation in the final list of recommendations:
displaying the recommendation and an explanation for the recommendation, wherein the explanation is associated with a document recommendation query used for retrieving the recommendation.

9. A system for providing recommendations to a user, comprising:
a network device comprising at least one processor coupled to a memory, the at least one processor operable to:
retrieve user information classified in a plurality of categories;
generate, for at least one of the plurality of categories, a document recommendation query based on the user information classified in a corresponding one of the plurality of categories;
retrieve, for each generated recommendation query, a plurality of documents satisfying the recommendation query, from a corpus of documents, wherein the corpus classifies a plurality of documents of a determined type available for consumption by the user; and
rank each retrieved plurality of documents to generate a final list of recommendations for the user, wherein the ranking is based on the user information classified in the plurality of categories.

10. The system according to claim 1, wherein the plurality of categories comprise two or more of:
user identification information comprising user name and age;
user location and demographic;
previous user purchases of documents available for user consumption;
user viewing history;
user media consumption history;
user interests; and
user's friends.

11. The system according to claim 1, wherein each of the plurality of documents comprises identifying information for at least one of a book, a song, a video, a movie, a music album, an application (app), and a TV show.

12. The system according to claim 1, wherein the at least one processor is operable to:
rank, for each of the generated recommendation query, the retrieved plurality of documents based on at least one predetermined ranking criteria.

13. The system according to claim 4, wherein the at least one processor is operable to:
generate the final list of recommendations for the user by selecting, for each of the generated recommendation query, a predetermined number of documents from the ranked plurality of documents.

14. The system according to claim 1, wherein, if the user information comprises the user's current location, then the document recommendation query comprises a query for at least one document popular at the user's current location.

15. The system according to claim 1, wherein, if the user information comprises identifying information about the user's friends, then the document recommendation query comprises a query for at least one document similar to:
a document recently purchased by at least one of the user's friends;
a document recommended by at least one of the user's friends; or
a document viewed by at least one of the user's friends.

16. The system according to claim 1, wherein the at least one processor is operable to:
for each recommendation in the final list of recommendations:
display the recommendation and an explanation for the recommendation, wherein the explanation is associated with a document recommendation query used for retrieving the recommendation.

17. A method for providing recommendations to a user, comprising:
retrieving user information classified in a plurality of categories;
retrieving information related to recent content consumed by the user;
generating at least one document recommendation query based on the retrieved user information;
retrieving, for each of the at least one document recommendation query, a plurality of documents satisfying the recommendation query, from a corpus of documents, wherein the corpus classifies a plurality of documents of a determined type available for consumption by the user; and
ranking each retrieved plurality of documents based on the recent content consumed by the user, to generate a final list of recommendations for the user, wherein the ranking is based on the user information classified in the plurality of categories.

18. The method according to claim 17, comprising:
assigning a weight to each of the retrieved plurality of documents based on similarity to the recent content consumed by the user.

19. The method according to claim 18, wherein each of the retrieved plurality of documents is ranked based on the assigned weight.

20. The method according to claim 17, comprising:
for each recommendation in the final list of recommendations:
displaying the recommendation and an explanation for the recommendation, wherein the explanation is associated with a document recommendation query used for retrieving the recommendation.
